(19) United States
(12) Patent Application Publication
(10) Pub. No.: US 2021/0273537 A1
(43) Pub. Date: Sep. 2, 2021

(54) METHOD OF MANUFACTURING STATOR

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventor: Takahiro TOI, Yokohama (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 17/320,454

(22) Filed: May 14, 2021

Related U.S. Application Data
(63) Continuation of application No. PCT/JP2018/042582, filed on Nov. 16, 2018.

(51) Int. Cl. H02K 15/085; H02K 15/04; H02K 3/12; H02K 15/06; H02K 15/02

(52) U.S. Cl. CPC H02K 15/085; H02K 15/0421; H02K 15/024; H02K 15/065; H02K 3/12

(57) ABSTRACT

According to one embodiment, each of a pair of straight sections of a coil segment is inserted into a slot of a stator core from a first end face side of the stator core, extension end sections of the straight sections are made to protrude from a second end face side of the stator core. A jig is arranged on the second end face side of the stator core in a state where each of extension end section hold sections of the coil segment is held by the jig, the position of the jig relative to the stator core is turned in a circumferential direction, a bend section positioned between the stator core and the jig is bent in the circumferential direction, and the whole of the extension end section hold section is cut off.

### CROSS-REFERENCE TO RELATED APPLICATIONS

This application is a Continuation Application of PCT Application No. PCT/JP2018/042582, filed Nov. 16, 2018, the entire contents of which are incorporated herein by reference.

### FIELD

Embodiments described herein relate generally to a method of manufacturing a stator.

### BACKGROUND

In recent years, owing to the remarkable research and development of a permanent magnet, a permanent magnet having a high magnetic energy product has been developed and, permanent magnet type rotating electrical machines using such permanent magnets are now being utilized as electric motors or generators of electric trains and automobiles. Normally, a permanent magnet type rotating electrical machine is provided with a cylindrical stator and columnar rotor rotatably supported inside this stator. The stator is provided with a stator core and coils attached to the stator core. A coil includes a coil end protruding from both end faces of the stator core in the axial direction. Regarding such a rotating electrical machine, downsizing and weight saving are desired.

### BRIEF DESCRIPTION OF THE DRAWINGS

FIG. 1 is a vertical cross-sectional view showing an electric motor according to an embodiment.

FIG. 2 is a transverse cross-sectional view of the electric motor according to the embodiment.

FIG. 3 is a perspective view showing the first end face side of a stator of the electric motor.

FIG. 4 is a perspective view showing the second end face side of the stator of the electric motor.

FIG. 5 is a cross-sectional view showing one slot of the stator in an enlarged form.

FIG. 6 is a plan view showing a coil segment constituting a coil of the stator.

FIG. 7 is a view schematically showing a manufacturing process of the stator.

FIG. 8 is a perspective view showing a plurality of coil segments arranged in line.

FIG. 9 is a perspective exploded view showing coil segments arranged in a cylindrical form and stator core.

FIG. 10 is a perspective view showing a state where the coil segments arranged in a cylindrical form are attached to the stator core.

FIG. 11 is a view schematically showing a bending/forming step of coil segment straight sections to be carried out by using a bending jig.

FIG. 12 is a perspective view showing extension end sections of the bent/formed coil segments.

FIG. 13 is a view showing cutting positions of the bent/formed coil segments.

FIG. 14 is a view schematically showing the cut configuration of the extension end sections of the coil segments.

FIG. 15 is a plan view schematically showing the cut sections in a state where the cut sections are deformed by cutting.

FIG. 16 is a perspective view showing the cut and welded extension end sections of the coil segments.

FIG. 17 is a side view showing a part of the stator manufactured by the manufacturing method according to this embodiment.

### DETAILED DESCRIPTION

Various embodiments will be described hereinafter with reference to the accompanying drawings. In general, according to one embodiment, a method of manufacturing a stator comprises: preparing a plurality of coil segments each of which is constituted of a rectangular conductor including, as one body, a pair of straight sections opposed to each other with a distance held in between, and a bridging section connecting one ends of the straight sections to each other; inserting each of the pair of straight sections into a slot of a stator core from a first end face side of the stator core, positioning the bridging section in opposition to the first end face, and making extension end sections of the pair of straight sections protrude from a second end face side of the stator core in an axial direction; arranging a jig capable of holding each of the extension end sections of the coil segment in such a manner as to be separate from the second end face side in a central axis line direction of the stator core, and making the jig hold each of extension end section hold sections each of which is a part of the extension end section of the coil segment on the end section side thereof; turning, after the jig arrangement, the position of the jig relative to the stator core in a circumferential direction relative to the central axis line of the stator core to thereby bend a part of each of the extension end sections of each coil segment, namely, a bend section positioned between the stator core and the jig in the circumferential direction of the stator core; and cutting off the whole of the extension end section hold section of each coil segment bent in the bending.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

### Embodiments

First, an example of a rotating electrical machine to which a manufacturing method according to an embodiment is applied will be described.

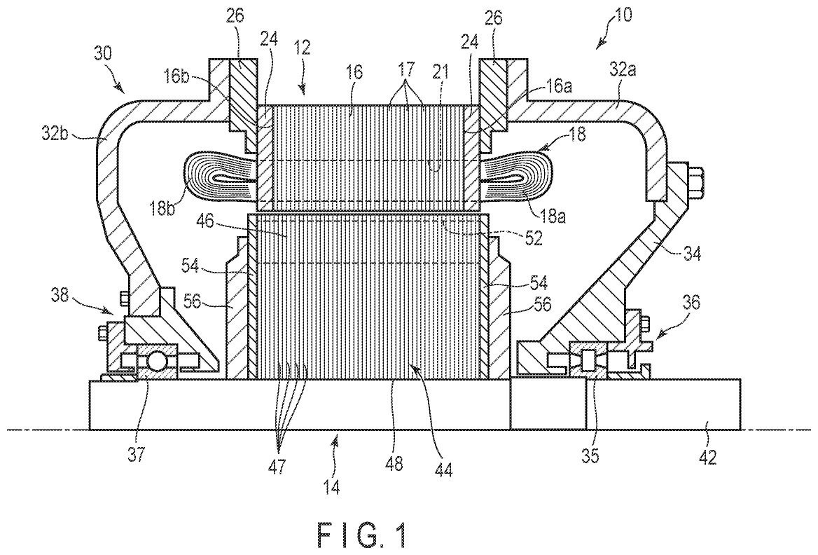

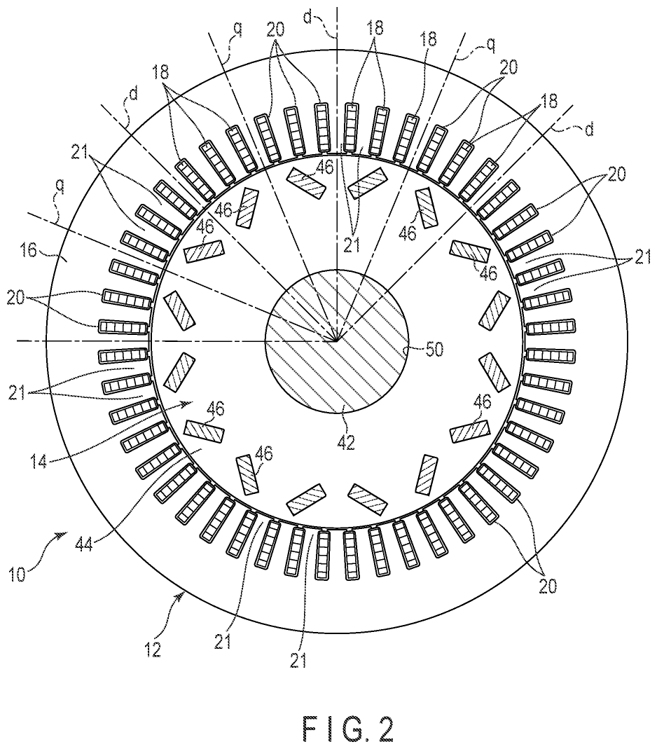

FIG. 1 is a vertical cross-sectional view of a rotating electrical machine according to the embodiment, and shows only a half thereof on one side of the central axis line C1 serving as the center of the rotating electrical machine. FIG. 2 is a transverse cross-sectional view of the rotating electrical machine.

As shown in FIG. 1, the rotating electrical machine 10 is configured as, for example, a permanent magnet type rotating electrical machine. The rotating electrical machine 10 is provided with an annular or cylindrical stator 12, rotor 14 supported inside the stator 12 in such a manner as to be rotatable around the central axis line C1 and to be coaxial with the stator 12, and casing 30 configured to support the stator 12 and rotor 14.

In the following description, the extension direction of the central axis line C1 is referred to as the axial direction, direction of rotation around the central axis line C1 is referred to as the circumferential direction, and direction orthogonal to both the axial direction and circumferential direction is referred to as the radial direction.

As shown in FIG. 1 and FIG. 2, the stator 12 is provided with a cylindrical stator core 16 and stator windings (coils) 18 attached to the stator core 16. The stator core 16 is formed by concentrically stacking a large number of annular magnetic steel sheets 17 of a magnetic material such as silicon steel or the like on top of each other in layers. A plurality of positions of the outer circumferential surface of the stator core 16 are subjected to welding, whereby the large number of magnetic steel sheets 17 are coupled to each other in the stacked state. The stator core 16 includes a first end face 16a positioned at one end thereof in the axial direction, and second end face 16b positioned at the other end thereof in the axial direction. The first end face 16a and second end face 16b respectively extend perpendicularly to the central axis line C1.

At the inner circumferential part of the stator core 16, a plurality of slots 20 are formed. The plurality of slots are arranged side by side at regular intervals in the inner circumferential direction. In this embodiment, each of the slots 20 is opened to the inner circumferential surface of the stator core 16. Each of the slots 20 extends from the inner circumferential surface side of the stator core 16 in the radiation direction (outwardly in the radial direction relative to the central axis of the stator core 16). Each of the slots 20 extends throughout the entire length of the stator core 16 in the axial direction thereof. One end of each of the slots 20 in the axial direction is opened to the first end face 16a, and the other end thereof in the axial direction is opened to the second end face 16b. It should be noted that it is also acceptable to configure the stator core 16 in such a manner that the end section of each of the slots 20 on the inner circumferential side is not opened to the inner circumferential side of the stator core 16, and make the inner circumferential surface of the stator core 16 a cylindrical inner surface.

The plurality of slots 20 are formed, whereby the inner circumferential section of the stator core 16 constitutes a plurality of (for example, in this embodiment, 48) teeth 21 protruding toward the central axis line C1. The teeth 21 are arranged at regular intervals in the inner circumferential direction. As described above, the stator core 16 includes, as one body, an annular yoke section and the plurality of teeth 21 protruding in the radial direction from the inner circumferential surface of the yoke section toward the central axis line C1.

The coils 18 are embedded in the plurality of slots 20 and are respectively wound around the teeth 21. Each of the coils 18 is provided in such a manner as to include coil ends 18a and 18b outwardly extending in the axial direction respectively from the first end face 16a and second end face 16b of the stator core 16. An alternating current is made to flow through each of the coils 18, whereby a predetermined interlinkage magnetic flux is formed in the stator 12 (teeth 21).

As shown in FIG. 1, at each of both ends of the stator core 16 in the axial direction, a core end plate (hereinafter referred to as an end plate) 24 having a cross-sectional shape approximately identical to the stator core 16 is provided. Furthermore, a core holding member 26 is provided on each of the end plates 24.

The casing 30 includes a first bracket 32a having approximately a cylindrical shape, and bowl-shaped second bracket 32b. The first bracket 32a is coupled to the core holding member 26 positioned on the drive-end side of the stator core 16. The second bracket 32b is coupled to the core holding member 26 positioned on the counter-drive-end side. The first and second brackets 32a and 32b are formed of, for example, an aluminum alloy or the like. An annular bearing bracket 34 is coaxially fastened to the tip end side of the first bracket 32a by means of bolts. A first bearing section 36 incorporating therein, for example, a roller bearing 35 is fastened to a central part of the bearing bracket 34. A second bearing section 38 incorporating therein, for example, a ball bearing 37 is fastened to a central part of the second bracket 32b.

On the other hand, the rotor 14 includes a columnar shaft (rotational axis) 42 supported by the first and second bearing sections 36 and 38 in such a manner as to be rotatable around the central axis line C1, cylindrical rotor core 44 fixed to the shaft 42 at approximately a central part thereof in the axial direction, and a plurality of permanent magnets 46 embedded in the rotor core 44. The rotor core 44 is configured as a laminated body formed by concentrically laminating a large number of annular magnetic steel sheets 47 of a magnetic material such as silicon steel or the like. The rotor core 44 includes an inner hole 48 formed coaxially with the central axis line C1. The shaft 42 is inserted/fitted into the inner hole 48 and extends coaxially with the rotor core 44. A magnetic shielding plate 54 having approximately a disk-like shape and rotor core holding member 56 are provided at each of both ends of the rotor core 44 in the axial direction thereof.

As shown in FIG. 1 and FIG. 2, the rotor core 44 is coaxially arranged inside the stator core 16 with a thin gap (air gap) held between them. That is, the outer circumferential surface of the rotor core 44 is opposed to the inner circumferential surface (apical surfaces of the teeth 21) of the stator core 16 with a thin gap held between them.

A plurality of magnet-embedding holes 52 penetrating through the rotor core 44 in the axial direction are formed in the rotor core 44. A permanent magnet 46 is loaded into and arranged in each of the magnet-embedding holes 52, and is fixed to the rotor core 44 with, for example, an adhesive or the like. Each of the permanent magnets 46 extends throughout the entire length of the rotor core 44. Further, the plurality of permanent magnets 46 are arranged in the circumferential direction of the rotor core 44 at predetermined intervals.

As shown in FIG. 2, the rotor core 44 has d axes each extending in the radial directions or radiation directions of the rotor core 44 and q axes each electrically separate from the d axes by 90°. Here, axes extending in the radiation directions through boundaries between adjacent magnetic poles and the central axis line C1 are regarded as the q axes, and directions electrically orthogonal to the q axes are regarded as the d axes. The d axes and q axes are provided alternately in the circumferential direction of the rotor core 44 and in predetermined phase.

In the circumferential direction of the rotor core 44, each of two magnet-embedding holes 52 is formed on each of both sides of each d axis. Each of the magnet-embedding holes 52 penetrates through the rotor core 44 in the axial direction thereof to thereby extend throughout the length of the rotor core 44. Each of the magnet-embedding holes 52 has approximately a rectangular cross-sectional shape, and is diagonal to the d axis. When viewed at a plane orthogonal to the central axis line C1 of the rotor core 44, the two magnet-embedding holes 52 are arranged side by side in, for example, approximately a V-shape. Here, the ends of the magnet-embedding holes 52 on the inner circumference side are respectively adjacent to the d axis and are opposed to each other with a small gap held between them. The ends of the magnet-embedding holes 52 on the outer circumference side are separate from the d axis in the circumferential direction of the rotor core 44, and are positioned in the vicinities of the outer circumferential surface of the rotor core 44 and in the vicinities of the q axes. Thereby, each of the ends of the magnet-embedding holes 52 on the outer circumference side is opposed to the outer circumference side end of the magnet-embedding hole 52 of the adjacent magnetic pole with the q axis interposed between them. In the rotor core 44, a magnetic path narrow section (bridge section) having a small width is formed between the outer circumference side end of each of the magnet-embedding holes 52 and outer circumferential edge of the rotor core 44.

A plurality of void holes (through holes) 31 are formed in the rotor core 44. Each of the void holes 31 penetrates through the rotor core 44 in the axial direction thereof to thereby extend throughout the length of the rotor core 44. Each of the void holes 31 is positioned on the q axis and is provided between the two magnet-embedding holes 52 of the adjacent magnetic poles.

Each permanent magnet 46 is loaded into each magnet-embedding hole 52 and is embedded in the rotor core 44. The permanent magnet 46 is formed into, for example, a long and thin plate-like shape having a rectangular cross section and has a length approximately equal to the length of the rotor core 44 in the axial direction thereof. The permanent magnet 46 may be configured by combining a plurality of magnets divided in the axial direction (longitudinal direction) or in the circumferential direction (width direction) and, in this case, the plurality of magnets are formed in such a manner that the total length of the magnets becomes approximately equal to the length of the rotor core 44 in the axial direction thereof. Each of the permanent magnets 46 is embedded in the rotor core 44 throughout approximately the entire length of the rotor core 44. The magnetization direction of the permanent magnet 46 is made the direction orthogonal to the front surface and underside of the permanent magnet 46.

The permanent magnet 46 is loaded into the magnet-embedding hole 52 and is fixed to the rotor core 44 with an adhesive or the like.

The two permanent magnets 46 separately positioned on both sides of each d axis are arranged sided by side in approximately a V-shape. That is, the two permanent magnets 46 are arranged in such a manner that the distance from the d axis to each of the two permanent magnets 46 becomes gradually greater from the inner circumference side end to the outer circumference side end of the rotor core 44. The two permanent magnets 46 separately positioned on both sides of each d axis are arranged in such a manner that the magnetization directions of the permanent magnets 46 are opposite to each other in the circumferential direction of the rotor core 44, and two permanent magnets 46 separately positioned on both sides of each q axis are arranged in such a manner that the magnetization directions of the permanent magnets 46 are identical to each other.

The plurality of permanent magnets 46 are arranged in the manner described above, whereby an area on each d axis forms a magnetic pole at the center thereof at the outer circumferential section of the rotor core 44. In this embodiment, the rotating electrical machine 10 constitutes an embedded permanent magnet type rotating electrical machine which has 8 poles (four pole pairs) and 48 slots and is wound in single-layer distributed winding, and in which the back and front of each permanent magnet 46 respectively having a south pole and north pole are alternately arranged for each of adjacent magnetic poles.

Next, the configuration of the stator 12 and manufacturing method thereof will be described below.

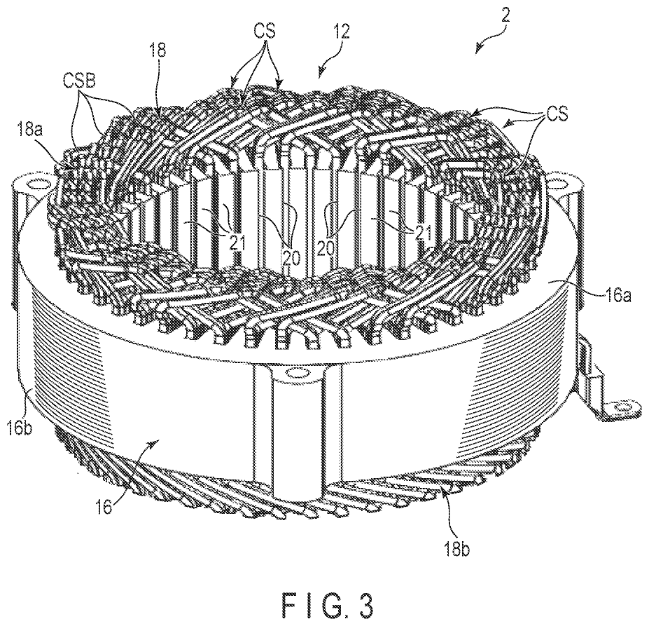

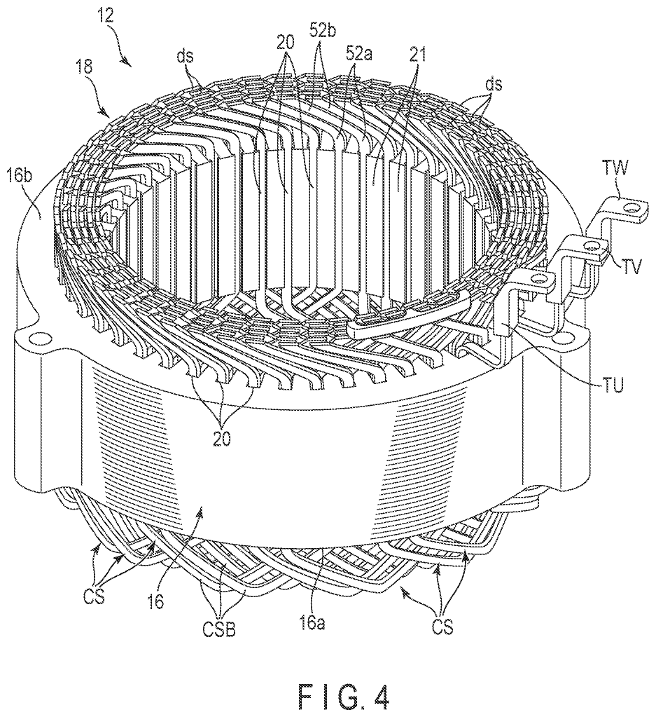

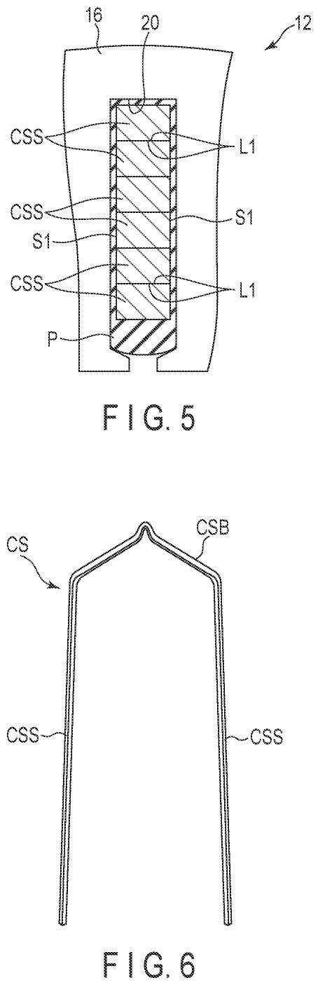

FIG. 3 is a perspective view showing the first end face side of the stator, FIG. 4 is a perspective view showing the second end face side of the stator, FIG. 5 is a cross-sectional view showing one slot extending in the radial direction in an enlarged form, and FIG. 6 is a view showing an example of a coil segment.

The coil 18 is configured by the use of a plurality of coil segments CS constituted of rectangular wires serving as rectangular conductors, and is incorporated in the stator core 16. The rectangular conductor has such a shape that a section (cross section) thereof perpendicular to the longitudinal direction is approximately rectangular or has at least such a shape that the shape of the cross section thereof perpendicular to the longitudinal direction has two long sides opposed to each other. When the cross section of the rectangular conductor is a rectangle, four corners thereof are not necessarily regular right angles and may also be subjected to chamfering or corner rounding. Further, when the cross section has two long sides opposed to each other, the part of each of the opposed two long sides connecting both ends thereof in the cross section may also be a curved line such as a part of an oblong shape. As shown in FIG. 6, the coil segment CS is formed into approximately a U-shape by cutting and bending a rectangular wire. That is, the coil segment CS includes, as one body, a pair of straight sections CSS opposed to each other with a distance held between them, and bridging section CSB connected to each of one end sections of the straight sections CSS. The coil segment CS has a rectangular cross-sectional shape, i.e., the cross section has a pair of long sides L1 opposed to each other and a pair of short sides S1 opposed to each other. An outer surface of the coil segment CS is covered with an insulating coating. The extension end section of each of the straight sections CSS is subjected to coating removal and forms a conducting section capable of conducting electricity.

As shown in FIG. 3 and FIG. 4, in the plurality of coil segments CS, a pair of straight sections CSS are each inserted into corresponding and different slots 20 from the first end face 16a side of the stator core 16, and are made to protrude from the second end face 16b of the stator core 16 by predetermined lengths. As shown in FIG. 5, the straight sections CSS of, for example, six coil segments CS are inserted into one slot 20. The six straight sections CSS are arranged in line in the radial direction of the stator core 16 inside the slot 20. When viewed at the cross section, the six straight sections CSS are arranged inside the slot 20 in a state where the long sides L1 of the straight sections CSS are opposed to each other in parallel. Insulating paper P is wrapped around the outer surface of each straight section CSS, and the straight sections CSS are inserted into the slot 20 together with the insulating paper P. It should be noted that the insulating paper P may be inserted in advance into the slot 20 and the coil 18 may be inserted into the slot 20 in a state where the insulating paper P is already arranged inside the slot 20. The insulating paper P electrically and externally insulates the coil 18 and physically protects the coil 18.

As shown in FIG. 3, the bridging section CSB of the coil segment CS is opposed to the first end face 16a of the stator core 16 with a small gap held between them. The bridging sections CSB extend in approximately the circumferential direction of the stator core 16, and some of the bridging sections CSB extend to intersect other bridging sections CSB. These bridging sections CSB constitute a coil end 18a protruding from the first end face 16a.

As shown in FIG. 4, on the second end face 16b side of the stator core 16, the straight sections CSS of each coil segment CS penetrate through the slot 20 and, thereafter extend and protrude from the second end face 16b of the stator core 16 by predetermined lengths in the axial direction. The extension sections of the straight sections CSS are bent in the circumferential direction of the stator core 16 and extend diagonal to the axial direction. Furthermore, the extension ends of the straight sections CSS are obliquely cut and have end faces extending approximately in parallel with the second end face 16b.

The six straight sections CSS inserted into each slot 20 are alternately bent in one direction and opposite direction. That is, the straight section CSS positioned at the outermost periphery (layer) is bent in one of the circumferential directions of the stator core 16, and straight section CSS positioned at the second layer from the outermost layer is bent in the other (opposite direction) of the circumferential directions. The straight section CSS positioned at inwardly the next layer (third layer from the top) is bent in the one direction described above. End faces of six straight sections CSS extending from each of a plurality of slots 20 different from each other are positioned approximately in line in the radial direction of the stator core 16. These six end faces extend in approximately the same plane.

The end faces of the six straight sections CSS in each line are welded to each other by twos (by two straight sections) thereby acquiring electrical conduction. As the welding, for example, laser welding can be used. The welded part or joint part is covered with an insulating material such as powder paint, varnish or the like. The extension end sections of these straight sections CSS constitute a coil end 18 protruding from the second end face 16b. To three coils among the coils 18, a U-phase connection terminal TU, V-phase connection terminal TV, and W-phase connection terminal TW are respectively connected. In this embodiment, a case where the parallel number of the coils of the stator 12 is made one is exemplified and, when the parallel number of the coils with which the stator 12 is provided is a plural number, connection terminals corresponding to the coil parallel number are provided.

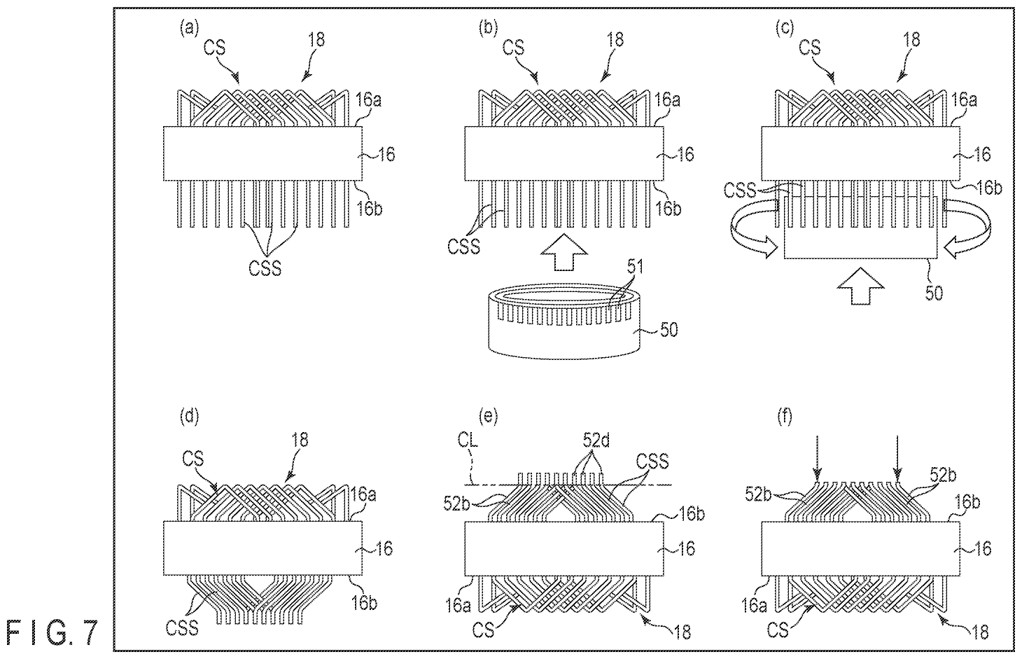

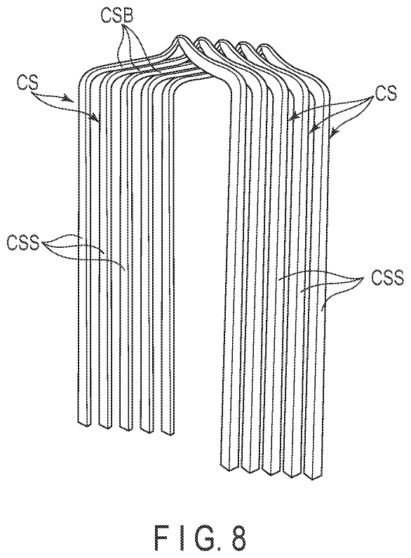

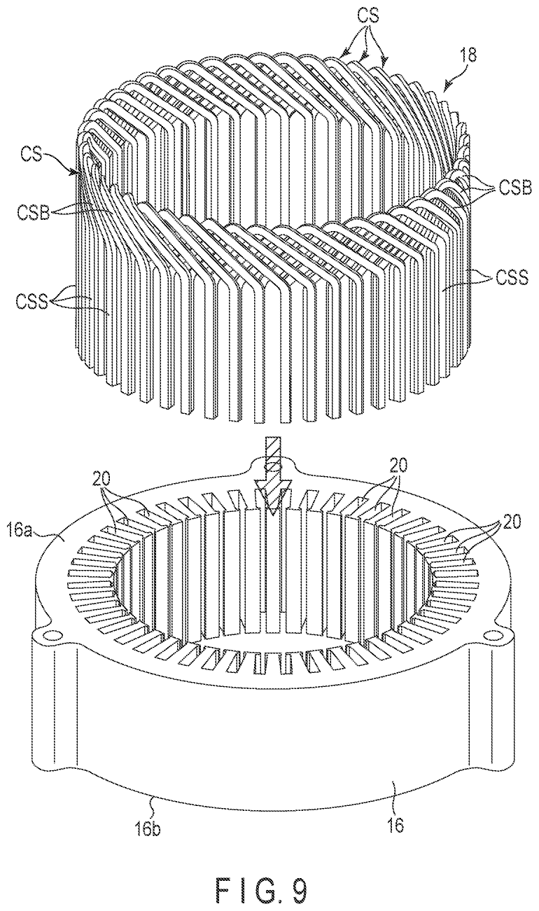

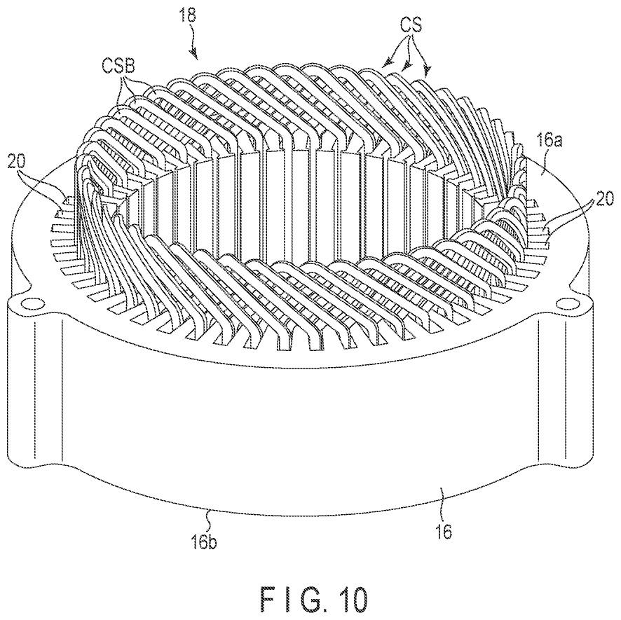

FIG. 7 is a view schematically showing a manufacturing process of the stator 12 configured as described above, FIG. 8 is a perspective view showing a plurality of coil segments, FIG. 9 is a perspective exploded view showing coil segments arranged in a cylindrical form and stator core, and FIG. 10 is a perspective view showing a state where the coil segments are inserted into the stator core.

In the manufacturing process of the stator 12, first, a large number of coil segments CS are prepared, and these coil segments CS are arranged in a cylindrical form as shown in FIG. 8 and FIG. 9. Although not shown, three sets of coil segments CS each arranged in a cylindrical form are prepared. Subsequently, as shown in (a) of FIG. 7 and FIG. 10, the coil segments CS arranged in a cylindrical form are inserted into the corresponding slots 20 from the first end face 16a side of the stator core 16. At this time, the straight sections CSS of the coil segments CS are inserted into the corresponding slots 20 and are made to protrude from the second end face 16b of the stator core 16 by predetermined lengths. Straight sections CSS of six coil segments CS are inserted into one slot 20.

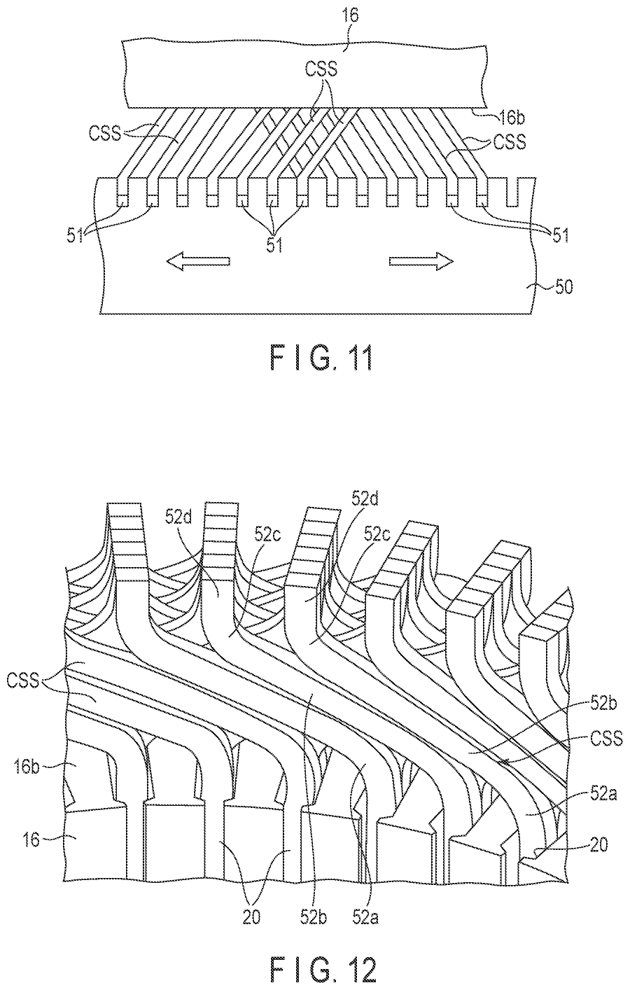

Subsequently, as shown in (b) and (c) of FIG. 7 and FIG. 11, a cylindrical bending jig 50 is set to the extension ends of the coil segments CS from the second end face 16b side. In one example, the bending jig 50 includes a plurality of annular members arranged in such a manner as to be coaxial with each other and to be rotatable relatively to each other, and a plurality of linear engaging concave sections 51 are provided at an end of each of the annual members. The bending jig 50 is set to the coil segments CS in a state where the extension end sections of the straight sections CSS are kept inserted into the engaging concave sections 51 and thereby held. A part of the extension end section of the straight section CSS (coil segment CS) inserted into the engaging concave section 51 of the bending jig 50 is called an extension end section hold section. The extension end section hold section constitutes a part of the extension end section of the coil segment CS on the end section side thereof. In the state where the bending jig 50 is set to the extension end sections of the coil segments CS, the bending jig 50 is separate from the second end face 16b of the stator core 16 in the central axis direction of the stator core 16. It should be noted that holding of the extension end sections of the coil segments CS by means of the bending jig 50 may not be intended to securely fix each of the extension end sections of the coil segments CS. That is, it is sufficient if the extension end sections of the coil segments CS can be inserted into the engaging concave sections 51 of the bending jig 50, and the gap between (in the circumferential direction, in the radial direction and/or in the axial direction) the inside dimension of the engaging concave section 51 and outside dimension of the extension end section of the coil segment CS is permissible.

In this state, the plurality of annular members of the bending jig 50 are turned in the clockwise direction or in the counterclockwise direction, whereby the position of the bending jig 50 relative to the stator core 16 is turned (moved) in the circumferential direction, and straight sections CSS of the coil segments CS are bent in the circumferential direction of the stator core 16 and are made oblique to the axial direction. At this time, the six straight sections CSS inserted into the slot 20 are alternately bent in one direction and in the other (opposite) direction. Thereafter, as shown in (d) of FIG. 7, the bending/forming is completed by removing the bending jig 50. In this manner, a part of the extension end section of the coil segment CS other than the part (extension end section hold section) inserted into the engaging concave section 51 of the bending jig 50 at the point in time when the turning of the bending jig 50 is completed, and positioned between the stator core 16 and bending jig 50 becomes the bend section.

FIG. 12 is a perspective view showing the bent/formed coil segments CS in an enlarged form. As shown in FIG. 12, each of the straight sections CSS of the coil segment CS includes, as one body, a first bend section 52a bent from the axial direction of the stator core 16 toward the circumferential direction by a predetermined angle, oblique section 52b linearly extending from the first bend section 52a obliquely to the axial direction, second bend section 52c bent at the extension end of the oblique section in the axial direction, and second straight section (hold section) 52d linearly extending from the second bend section 52c in the axial direction of the stator core 16. The second straight section (hold section) 52d is the part to be held by the bending jig 50. The hold sections 52d are arranged and positioned in line in the radial direction of the stator core 16 in groups of six.

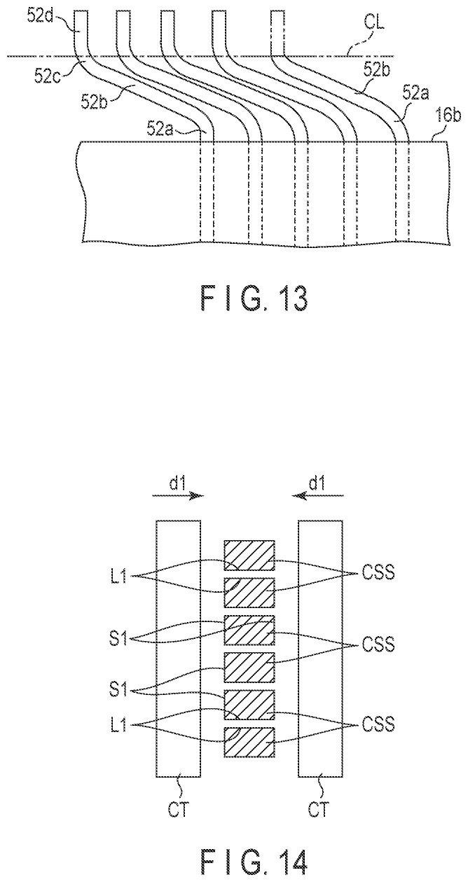

Subsequently, as shown in (e) of FIG. 7 and FIG. 13, the extension end sections of the straight sections CSS are cut along the cutting line CL, whereby the whole of the hold section (second straight section) 52d, i.e., a part of the extension end section of the straight section CSS inserted into the engaging concave section 51 of the bending jig 50 at the point in time when the bending is completed is totally cut off. More specifically, the extension end section is cut at a position in the vicinity of the border between the second bend section 52c and oblique section 52b. The cutting position may be within the second bend section 52c or may be within the oblique section 52b as far as the cutting position is in the vicinity of the aforementioned border and, furthermore, the cutting position may also be on the border. The cutting line CL is set inside the plane approximately parallel to the second end face 16b of the stator core 16. That is, by cutting off the extension end section, a cut surface (apical surface) ds approximately parallel to the second end face 16b is formed.

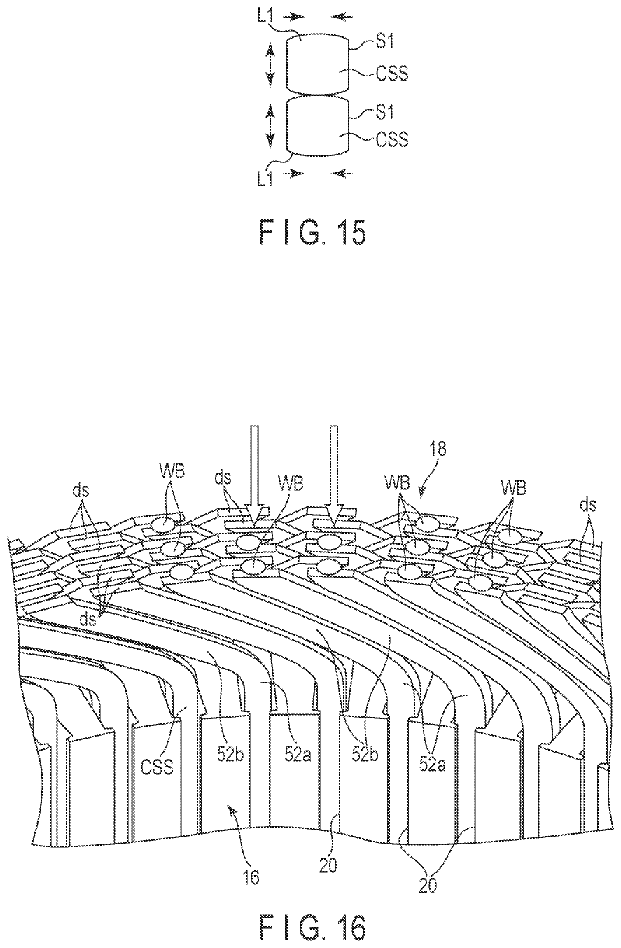

As shown in FIG. 14, in one example, the extension end section is cut by means of a cutting tool, for example, scissors CT. At this time, the six hold sections 52d arranged in line in the radial direction of the stator core 16 are cut by twos or the six hold sections 52d are cut at a time. The cutting direction, i.e., the moving directions of the edges of the scissors CT are made the circumferential directions of the stator core 16, i.e., the directions d1 parallel to the long side L1 of the straight section CSS. By setting the cutting directions d1 as described above, the cut section is compressed by the scissors CT as shown in FIG. 15 and is deformed in such a manner that the cut section is shrunk in the direction parallel to the long side L1 and is elongated in the direction parallel to the short side S1. Thereby, the straight sections CSS adjacent to each other are made closer to each other, whereby it becomes possible to make the gap between the straight sections CSS smaller. Making the gap smaller is more advantageous to the subsequent welding step. The cut surfaces ds of the six straight sections CSS arranged in line in the radial direction are arranged flush with each other at approximately the same height.

It should be noted that the cutting tool is not limited to the scissors, and other cutting tools such as a cutter, laser cutter, and the like can appropriately be selected.

Furthermore, removal (cutting off) of the hold section (second straight section) 52d may be carried out in the state where the extension end sections of the coil segments CS are kept inserted into the engaging concave sections 51 of the bending jig 50.

Further, it is desirable that the cutting off direction be made the circumferential direction, this being achieved by making the moving directions of the edges (or the light axis of the laser light in the case of a laser cutter) of the cutting tool at the time of cutting off the circumferential directions relative to the central axis of the stator core 16 or the directions perpendicular to the extension direction (radial direction) in which the slots 20 extend. In the case where the extension section of the coil segment CS is cut by moving the edges of the cutting tool in the circumferential directions, the force in the circumferential directions (or directions perpendicular to the radial direction) acts on the cut surface, whereby the cross-sectional shape is widened in the radial direction which is the extension direction of the slots 20, and hence the gap between the extension ends of two coil segments CS adjacent to each other in the radial direction is hardly created, and it becomes possible to make the joining capability of the extension end of the straight section CSS of the coil segment CS to be described below excellent. It should be noted that the cutting off direction may also be made the radial directions in addition to the circumferential directions.

After the cutting, as shown in (f) of FIG. 7 and FIG. 16, the extension ends of the two straight sections CSS adjacent to each other in the radial direction are joined to each other by welding. As the welding, laser welding is used. The cut surfaces ds of the two straight sections CSS adjacent to each other in the radial direction are irradiated with laser light, whereby the cut surfaces ds and extension ends are partially melted, and a weld bead WB extending astride the two cut surfaces ds is formed. The two adjacent straight sections CSS are mechanically and electrically joined to each other. The straight sections CSS of each line are welded and joined to each other in the same manner described above, whereby the three-phase coil 18 is formed.

Thereafter, each welded part or joint part is covered with an insulating material such as a powder paint, varnish or the like, whereby the electrical insulation between the coils is guaranteed. By the process described above, the coil 18 is attached to the stator core 16 and connection of the coil 18 is carried out, and thus the stator 12 is configured.

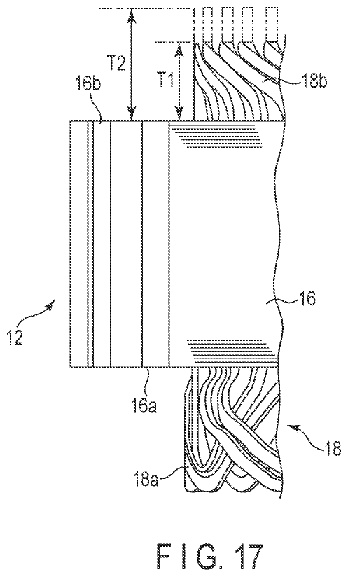

According to the stator configured as described above and manufacturing method thereof, by cutting off and removing the extension end sections of the coil segments CS, it is possible to largely reduce the protrusion height of the coil end 18b on the second end face 16b side of the stator core 16, and realize downsizing of the stator 12. In one example, as shown in FIG. 17, whereas the protrusion height T2 of the coil end 18b in which the second straight sections or the hold sections are still kept unremoved is about 29 mm, the protrusion height T1 of the coil end 18b of the stator 12 according to this embodiment is about 20 mm and the protrusion height is reduced by 30% or more.

Even when the second straight section or the hold section is cut off, it is easily possible to weld and join the coil segments to each other by using laser welding. By making the cut surface approximately parallel to the second end face 16b of the stator core 16, it is possible to further lower the height of the coil end 18b and easily carry out laser welding or joining.

Owing to the configuration in which cutting is carried out after the coil end is subjected to bending/forming, it is possible to carry out bending/forming by using the simple bending jig identical to the conventional one. At the same time, it is not necessary to form the extension end of the coil segment into an oblique shape in advance, and it becomes possible to realize simplification of the manufacturing process. By simultaneously cutting a pair of coil segments to be joined to each other, it is possible to enhance the adhesion strength of the joint part and, furthermore, eliminate the uneven step of the joint surface (cut surface). Thereby, it becomes possible to easily and stably carry out the subsequent welding step.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the number of turns in the coil and number of the applied coil segments are not limited to the embodiment described above, and can be appropriately increased or decreased. For example, the configuration may also be contrived in such a manner that four or eight segment straight sections are arranged inside one slot. The dimensions, material, shape, and the like of the rotor are not limited to the embodiment described previously, and can be variously changed according to the design. The rotor and electric motor according to this embodiment are not limited to the permanent magnet field electric motor, and the embodiment can also be applied to an induction motor.

What is claimed is:

1. A method of manufacturing a stator comprising:
preparing a plurality of coil segments each of which is constituted of a rectangular conductor including, as one body, a pair of straight sections opposed to each other with a distance held in between, and a bridging section connecting one ends of the straight sections to each other;
inserting each of the pair of straight sections into a slot of a stator core from a first end face side of the stator core, positioning the bridging section in opposition to the first end face, and making extension end sections of the pair of straight sections protrude from a second end face side of the stator core in an axial direction;
arranging a jig capable of holding each of the extension end sections of the coil segment in such a manner as to be separate from the second end face side in a central axis line direction of the stator core, and making the jig hold each of extension end section hold sections each of which is a part of the extension end section of the coil segment on the end section side thereof;
turning, after the jig arrangement, the position of the jig relative to the stator core in a circumferential direction relative to the central axis line of the stator core to thereby bend a part of each of the extension end sections of each coil segment, namely, a bend section positioned between the stator core and the jig in the circumferential direction of the stator core; and
cutting off the whole of the extension end section hold section of each coil segment bent in the bending.

2. The method of claim 1, wherein
by the bending, a first bend section bent from the slot toward the second end face of the stator core, an oblique section linearly extending from the first bend section obliquely to the axial direction of the stator core, a second bend section bent from the oblique section in the axial direction of the stator core, and a second straight section linearly extending from the second bend section in the axial direction of the stator core and held by the jig are formed in each of the extension end sections of the coil segment.

3. The method of claim 1, wherein
the cutting is carried out in a state where the jig keeps holding the extension end section hold section.

4. The method of claim 1, wherein
a cutting off direction in the cutting is made the circumferential direction.

5. The method of claim 1, wherein
a cut surface extending approximately in parallel with the second end face of the stator core is formed by the cutting, and cut surfaces adjacent to each other in a radial direction of the stator core are welded to each other by laser welding.

6. The method of claim 1, wherein
in the insertion, the plurality of coil segments are arranged in such a manner that the coil segments are lined inside one slot in the radial direction of the stator core, and long sides of cross sections of the coil segments are opposed to each other, and
in the cutting, the plurality of coil segments arranged inside the one slot are simultaneously cut.

7. The method of claim 2, wherein
the cutting is carried out in a state where the jig keeps holding the extension end section hold section.

8. The method of claim 2, wherein
a cutting off direction in the cutting is made the circumferential direction.

9. The method of claim 2, wherein
in the insertion, the plurality of coil segments are arranged in such a manner that the coil segments are lined inside one slot in the radial direction of the stator core, and long sides of cross sections of the coil segments are opposed to each other, and
in the cutting, the plurality of coil segments arranged inside the one slot are simultaneously cut.
